(19) United States
(12) Patent Application Publication
(10) Pub. No.: US 2010/0090921 A1
(43) Pub. Date: Apr. 15, 2010

(54) BUILT-IN ANTENNA DEVICE FOR PORTABLE WIRELESS TERMINAL

(75) Inventors: Jin-U KIM, Seoul (KR); Jae-Bong CHUN, Suwon-si (KR); Ji-Won KIM, Seoul (KR); Jae-Ho LEE, Yongin-si (KR); Byung-Man LIM, Seoul (KR); Seung-Hwan KIM, Suwon-si (KR)

Correspondence Address: Jefferson IP Law, LLP, 1130 Connecticut Ave., NW, Suite 420, Washington, DC, 20036, US

(73) Assignee: SAMSUNG ELECTRONICS CO. LTD., Suwon-si (TW)

(21) Appl. No.: 12/578,161

(22) Filed: Oct. 13, 2009

(30) Foreign Application Priority Data
Oct. 13, 2008 (KR) 10-2008-0100133

(51) Int. Cl. H01Q 1/48

(52) U.S. Cl. 343/848

(57) ABSTRACT

A built-in antenna device for improving the radiation efficiency in a portable wireless terminal having an external metallic part is provided. The built-in antenna device includes a main board, an antenna radiator, and a conductor. The main board has a feed pad for supplying an electrical signal and a ground pad connected to ground. The antenna radiator is connected electrically to the feed pad and the ground pad of the main board to radiate a signal. The conductor connects the metallic part and the ground pad of the main board. The metallic part and the ground pad of the main board are at the same ground potential.

### PRIORITY

This application claims the benefit under 35 U.S.C. §119(a) of a Korean patent application filed in the Korean Intellectual Property Office on Oct. 13, 2008 and assigned Serial No. 10-2008-0100133, the entire disclosure of which is hereby incorporated by reference.

### BACKGROUND OF THE INVENTION

1. Field of the Invention

The present invention relates to a built-in antenna device for a portable wireless terminal. More particularly, the present invention relates to a built-in antenna device to improve the radiation efficiency of a portable wireless terminal having a metallic case.

2. Description of the Related Art

As the electronic communication industry develops, portable wireless terminals are becoming lighter, slimmer, smaller, and more multi-functional. For example, a portable wireless terminal is now typically equipped with a speaker unit, capable of implementing various chords and melodies, and a color display unit, capable of displaying millions of pixels. Also, in addition to a call function, the portable wireless terminal now typically provides a music listening function through a Moving Picture Experts Group (MPEG) Audio Layer 3 (MP3) Player (MP3P). Furthermore, through the color display unit, the portable wireless terminal provides functions for receiving not only various game contents but also radio and Digital Multimedia Broadcast (DMB) contents.

In general, a portable wireless terminal uses a built-in antenna that allows the terminal to be made light and slim. However, if it is desired to provide the portable wireless terminal with greater radio wave transmission/reception, the built-in antenna is designed to be large so as to have high directivity. In such a case, the spacing distances between other parts within the terminal decrease in order to maintain the lightness and smallness of the portable wireless terminal. Therefore, it is difficult to secure the space for the larger antenna and improve the transmission/reception performance of the terminal. Furthermore, the portable wireless terminal typically uses a metallic cover and a metallic case frame for durability and appearance. Such use of the metallic cover and case further deteriorates the performance of the built-in antenna.

Accordingly, there is a need for a built-in antenna device for a portable wireless terminal to improve the radiation efficiency otherwise reduced by a metallic part of the portable wireless terminal.

### SUMMARY OF THE INVENTION

An aspect of the present invention is to address at least the above-mentioned problems and/or disadvantages and to provide at least the advantages described below. Accordingly, an aspect of the present invention is to provide a built-in antenna device for a portable wireless terminal to improve the radiation efficiency otherwise reduced by a metallic part of the portable wireless terminal

Another aspect of the present invention is to provide a built-in antenna device for a portable wireless terminal to improve the radiation efficiency by preventing a metallic part of the portable wireless terminal from consuming a current induced after transfer of an electromagnetic wave from an antenna radiator performing wireless communication.

Still another aspect of the present invention is to provide a built-in antenna device for a portable wireless terminal to improve the radiation efficiency by connecting a metallic part of the portable wireless terminal directly to an antenna radiator to use the metallic part as a ground part of the antenna radiator.

In accordance with an aspect of the present invention, a built-in antenna device for a portable wireless terminal having a metallic part is provided. The device includes a main board having a feed pad for supplying an electrical signal and a ground pad connected to ground, an antenna radiator, connected electrically to the feed pad and the ground pad of the main board, for radiating a signal, and a conductor electrically connecting the metallic part and the ground pad of the main board, wherein the metallic part and the ground pad of the main board are at the same ground potential.

In accordance with another aspect of the present invention, a built-in antenna device for a portable wireless terminal having a metallic part is provided. The device includes a main board including a feed pad for supplying an electrical signal and a ground pad connected to ground, an antenna radiator, connected electrically to the feed pad of the main board, for radiating a signal, at least one first connector electrically connecting the ground pad and the metallic part, and a second connector electrically connecting the antenna radiator and the metallic part, wherein the metallic part and the ground pad of the main board are at the same ground potential.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a perspective view of a portable wireless terminal according to an exemplary embodiment of the present invention;

FIG. 2 is a diagram illustrating a conventional built-in antenna device for a portable wireless terminal;

FIG. 3 is a diagram illustrating a built-in antenna device according to an exemplary embodiment of the present invention;

FIG. 4 is a diagram illustrating a built-in antenna device according to an exemplary embodiment of the present invention;

FIG. 5 is a diagram illustrating current distributions before and after connecting a metallic case frame directly to an antenna radiator for using the metallic case frame as a ground part of the antenna radiator according to an exemplary embodiment of the present invention; and

FIG. 6 is a diagram comparing the return loss and radiation efficiency of the conventional built-in antenna device with the return loss and radiation efficiency of the built-in antenna device according to an exemplary embodiment of the present invention.

Throughout the drawings, it should be noted that like reference numbers are used to depict the same or similar element, features and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a”, “an”, and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Exemplary embodiments of the present invention provide a built-in antenna device for a portable wireless terminal. More particularly, the present invention provides a built-in antenna device that is installed in a metallic frame to perform wireless communication and improve the radiation efficiency of a portable wireless terminal.

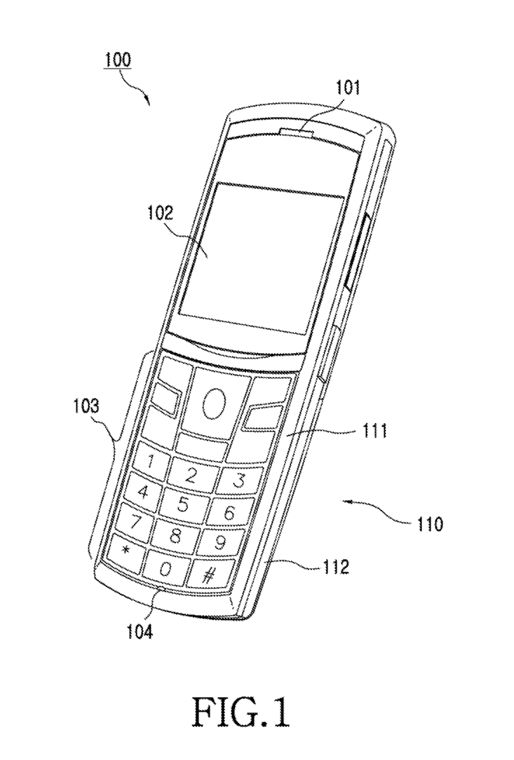

Exemplary embodiments of the present invention will be described in terms of a bar-type portable wireless terminal as illustrated in FIG. 1. However, the type of terminal is not limited to the bar-type. In an exemplary implementation, a variety of portable terminals may be used, such as, a folder type, a slide type, a flip type, a slide and rotation type, and the like.

FIG. 1 is a perspective view of a portable wireless terminal according to an exemplary embodiment of the present invention.

Referring to FIG. 1, a portable wireless terminal 100 includes a case frame 110 defining an outer surface thereof. The case frame 110 includes a top case frame 111 and a bottom case frame 112 coupled with the top case frame 111 to form a certain inner space. In an exemplary implementation, at least one of the top case frame 111 and the bottom case frame 112 is formed of a metallic material.

The portable wireless terminal 100 further includes a speakerphone 101 and a display 102 disposed near the speakerphone 101 to output a video signal. The case frame 110 further includes a keypad assembly 103 serving as a data input unit and a microphone 104 disposed near the keypad assembly 103 to input an audio signal. The display 102 may be a Liquid Crystal Display (LCD) with millions of pixels. In this case, if the LCD is provided with a touchscreen, the display 102 may serve as a supplemental data input unit or as a data unit in place of the keypad assembly 103.

According to an exemplary embodiment of the present invention, the portable wireless terminal 100 further includes a built-in antenna device (not illustrated) installed in the inner space of the metallic case frame 110 to perform wireless communication. The built-in antenna device includes an antenna radiator to radiate an electromagnetic wave. The antenna radiator is connected to a feed part of a main board (not illustrated) to radiate an electrical signal (e.g., a current) received from the feed part. The antenna radiator is also connected to a ground part of the main board.

According to an exemplary embodiment of the present invention, the built-in antenna device is electrically connected to the ground part of the main board and is also electrically connected to the metallic case frame 110 so that the case frame 110 and the ground part are at the same ground potential. In an exemplary implementation, the antenna radiator is connected directly to the metallic case frame 110. This is to establish the metallic case frame 110 and the ground part of the main board as the same ground potential. Thus, an exemplary built-in antenna device of the present invention prevents degradation of the radiation efficiency due to the electromagnetic wave, radiating from the antenna radiator, transferring to the metallic case frame 110 unnecessarily.

FIG. 2 is a diagram illustrating a conventional built-in antenna device for a portable wireless terminal.

Referring to FIG. 2, a conventional built-in antenna device 200 includes a main board 210 that has a feed pad connected to a feed part to supply an electrical signal for radiation by an antenna. The main board 210 also has a ground pad connected to ground and having a certain area. The built-in antenna device 200 further includes an antenna radiator 220 connected to the feed pad and the ground pad of the main board 210 to radiate an electromagnetic wave. The built-in antenna device 200 further includes conductors 221 and 222 that respectively connect the antenna radiator 220 to the feed pad and the ground pad of the main board 210. In an exemplary implementation, the antenna radiator 220 includes a thin plate with a radiation pattern.

The conventional portable wireless terminal includes a metallic case frame 230 that is spaced apart from the built-in antenna device 200 to define an outer surface of the portable wireless terminal. As described above, the antenna radiator 220 radiates an electrical signal (e.g., a current) received from the feed pad of the main board 210 through the conductor 221. When the antenna radiator 220 radiates the electrical signal, an electromagnetic wave (i.e. energy) is generated in order to transmit the desired information. However, some of the radiation from the antenna radiator 220 transfers to the metallic case frame 230. The electromagnetic wave received by the metallic case frame 230 induces a current, and the induced current flows through the metallic case frame 230. That is, by receiving the electromagnetic wave which induces current, the metallic case frame 230 degrades the radiation efficiency of the built-in antenna device 200. One option to address this concern is to increase the spacing distance between the antenna radiator 220 and the metallic case frame 230. However, this would increase the size of the portable wireless terminal.

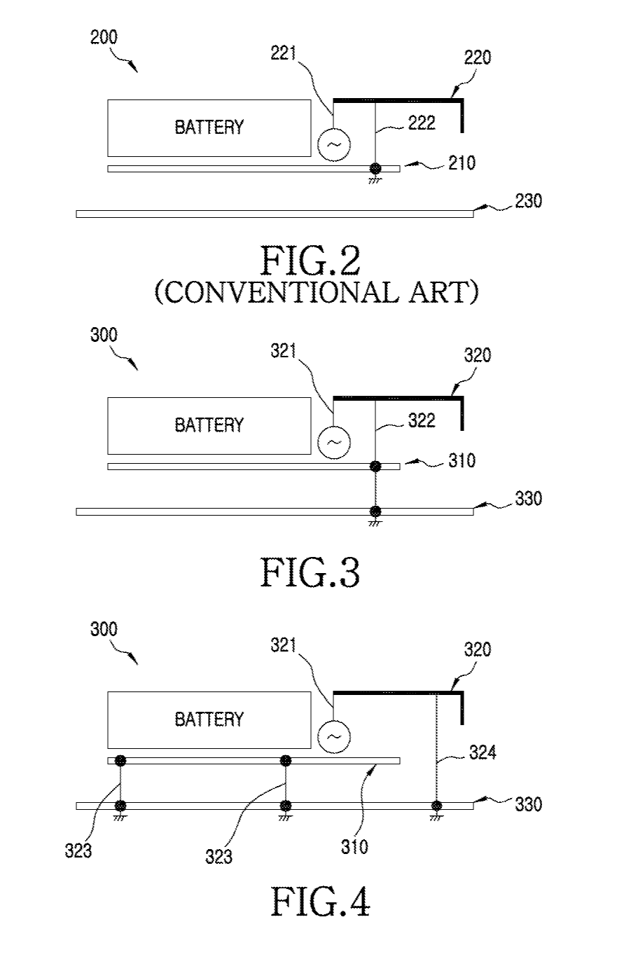

FIG. 3 is a diagram illustrating a built-in antenna device according to an exemplary embodiment of the present invention.

Referring to FIG. 3, a built-in antenna device 300 includes a main board 310 that has a feed pad connected to a feed part to supply an electrical signal for radiation by an antenna. The main board 310 also has a ground pad connected to ground and having a certain area. The built-in antenna device 300 further includes an antenna radiator 320 that is connected to the feed pad and the ground pad of the main board 310 to radiate an electromagnetic wave. The built-in antenna device 300 also includes a metallic case frame 330 that is spaced apart from the main board 310 to define an outer surface of the portable wireless terminal. The built-in antenna device 300 further includes a feed conductor 321 that connects the antenna radiator 320 to the feed pad of the main board 310. In an exemplary implementation, the built-in antenna device 300 further includes a ground conductor 322 that connects the metallic case frame 330 to the ground pad of the main board 310. In an exemplary implementation, the antenna radiator 320 is electrically connected directly to the metallic case frame 330 and the ground pad of the main board 310 using the ground conductor 322. Thus, the built-in antenna device 300 establishes the metallic case frame 330 and the ground pad of the main board 310 at the same ground potential, thereby preventing the electromagnetic wave of the antenna radiator 320 from transferring to the metallic case frame 330.

For convenience of description, the exemplary embodiment of FIG. 3 illustrates that the built-in antenna device 300 has only the metallic case frame 330 disposed under the main board 310. However, as illustrated in FIG. 1, the built-in antenna device 300 may also include another metallic case frame that is disposed over the antenna radiator 320 and is electrically connected through a conductor to the ground pad so that it is at the same ground potential. In an exemplary implementation, the other metallic case frame may be connected to the same ground potential using ground conductor 322 or a separate conductor.

The ground conductor 322 may be connected to the antenna radiator 320 and the metallic case frame 330 directly through the ground pad of the main board 310. For example, the ground conductor 322 may be connected to the ground pad by being inserted through a hole in the ground pad of the main board 310. If so, the ground conductor 322 may include a pin, such as a fogo pin, that electrically connects the antenna radiator 320 and the metallic case frame 330 directly through the hole in the ground pad. Of course, the pin would be soldered or otherwise electrically connected to the ground pad as it passes through the hole.

In an exemplary implementation, the ground conductor 322 may include a via connected to the ground pad of the main board, a pad formed on the opposite side of the main board 310 through the via, and a conductor, such as a conductive sponge, a conductive tape, a session cable and the like, connected electrically to the ground pad.

The ground conductor 322 may also include a conductive screw that fixes the antenna radiator 320, the ground pad of the main board 310, and the metallic case frame 330 at regular intervals and electrically connects them.

The feed conductor 321 may include at least one of a conductive screw, a conductive plate, a conductive sponge, a conductive tape, a pin, and a session cable that has one end connected to the antenna radiator 320 and the other end connected to the feed pad. A description of its detailed structure will be omitted for conciseness.

FIG. 4 is a diagram illustrating a built-in antenna device according to an exemplary embodiment of the present invention.

Referring to FIG. 4, a built-in antenna device 300 includes a main board 310 that has a feed pad connected to a feed part to supply an electrical signal for radiation by an antenna. The main board 310 also has a ground pad that is connected to ground and has a certain area. The built-in antenna device 300 further includes an antenna radiator 320 that is connected through a feed conductor 321 to the feed pad of the main board 310 to radiate an electromagnetic wave. The built-in antenna device 300 also includes a metallic case frame 330 that is spaced apart from the main board 310 to define a surface of a portable wireless terminal. The metallic case frame 330 serves to connect the antenna radiator 320 and the ground pad of the main board 310. That is, as illustrated in FIG. 4, the antenna radiator 320 is connected to a ground terminal of the metallic case frame 330 through a second ground conductor 324 and the metallic case frame 330 is connected to ground terminals on the main board through first ground conductors 323. Accordingly, the antenna radiator 320 is electrically connected to the main board 310 via the metallic case frame 330. In an exemplary implementation, the built-in antenna device 300 includes at least one first ground conductor 323 that connects the metallic case frame 330 and the ground pad of the main board 310. In the illustrated example of FIG. 4, two first ground conductors 323 are illustrated. However, the built-in antenna device may include only one first ground conductor 323 or three or more first ground conductors 323. In addition, the built-in antenna device 300 further includes second ground conductor 324 that connects the antenna radiator 320 and the metallic case frame 330 directly. It is to be noted that while only one second ground conductor 324 is illustrated, additional second ground conductors are also contemplated by the present invention. According to the illustrated exemplary embodiment of FIG. 4, the built-in antenna device 300 places the metallic case frame 330 and the ground pad of the main board 310 at the same ground potential, thereby preventing the electromagnetic wave of the antenna radiator 320 from transferring to the metallic case frame 330.

The first ground conductor 323 may use a pin to connect the metallic case frame 330 and the ground pad of the main board 310.

The first ground conductor 323 may use at least one of a conductive plate, a conductive sponge, a conductive tape and a session cable. In an exemplary implementation, the first ground conductor 323 may include a via through which one end is connected to the ground pad of the main board 310.

The first ground conductor 323 may include a screw hole formed in the main board 310 to connect to the ground pad of the main board 310, and a conductive screw inserted into the screw hole and fixed to the metallic case frame 330 and the main board 310.

The feed conductor 321 and the second ground conductor 324 may include at least one of conductors, such as a conductive screw, a conductive plate, a conductive sponge, a conductive tape, a pin and the like. A description of their detailed structure will be omitted for conciseness.

For convenience of description, the exemplary embodiment of FIG. 4 illustrates that the built-in antenna device 300 has only the metallic case frame 330 disposed under the main board 310. However, as illustrated in FIG. 1, the built-in antenna device 300 may also include another metallic case frame that is disposed over the antenna radiator 320 and is electrically connected through a conductor to the ground pad so that it is at the same ground potential. In an exemplary implementation, the other metallic case frame may be connected to the same ground potential using first ground conductor 323, second ground conductor 324, or a separate conductor.

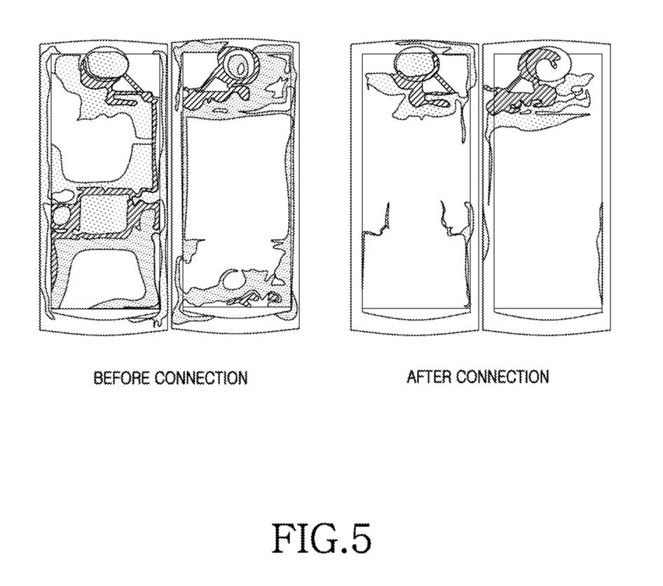

FIG. 5 is a diagram illustrating current distributions before and after connecting the metallic case frame directly to the antenna radiator so that the metallic case frame is at the same potential as the ground pad of the antenna radiator according to an exemplary embodiment of the present invention.

Referring to FIG. 5, by connecting the metallic case frame 330 to the antenna radiator 320, the current induced in the metallic case frame 330 is reduced in comparison with the case of non-connection. This means that exemplary embodiments of the present invention reduce the loss of the antenna radiator 320 and improve the radiation efficiency.

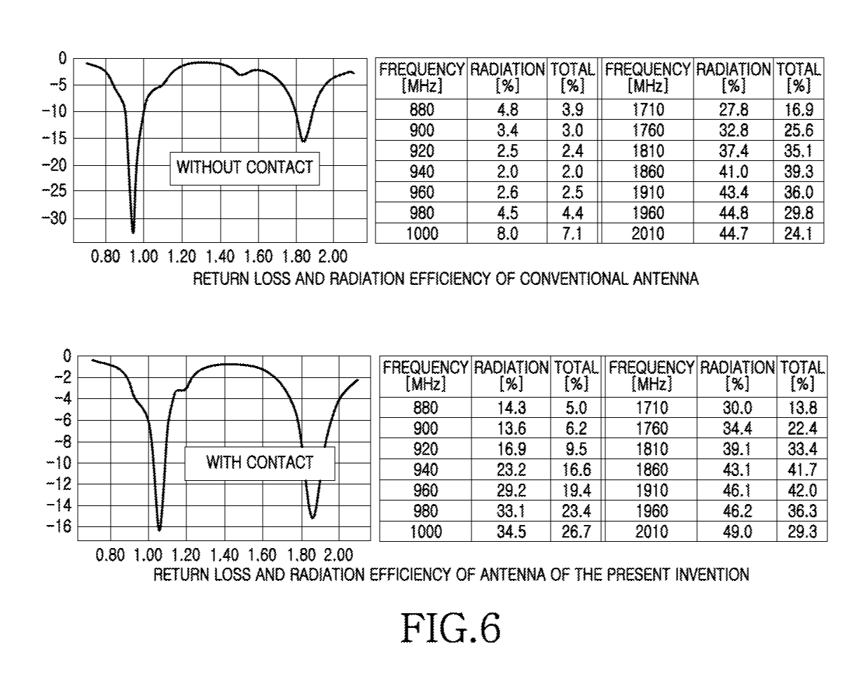

FIG. 6 is a diagram comparing the loss and radiation efficiency of the conventional built-in antenna device with the loss and radiation efficiency of a built-in antenna device according to an exemplary embodiment of the present invention.

Referring to FIG. 6, an exemplary embodiment of the present invention establishes the metallic case frame 330 and the main board 310 to have the same ground potential. Thus, in comparison with the conventional built-in antenna device 200, an exemplary built-in antenna device 300 of an exemplary embodiment of the present invention reduces the loss of the antenna and increases the radiation efficiency throughout the frequency band.

As described above, a built-in antenna device for a portable wireless terminal according to exemplary embodiments of the present invention prevents the metallic part of the portable wireless terminal from consuming the current induced after transfer of the electromagnetic wave from the antenna radiator, thereby making it possible to improve the radiation efficiency of the antenna radiator.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A built-in antenna device for a portable wireless terminal having a metallic part, the device comprising:
a main board having a feed pad for supplying an electrical signal and a ground pad connected to ground;
an antenna radiator connected electrically to the feed pad and the ground pad for radiating a signal; and
a conductor electrically connecting the metallic part and the ground pad of the main board,
wherein the metallic part and the ground pad of the main board are at the same ground potential.

2. The device of claim 1, wherein the conductor includes at least one of a session cable, a conductive tape, and a conductive sponge.

3. The device of claim 1, wherein the conductor includes at least one of a metallic rod, a metallic screw, and a pin that electrically connects the metallic part and the ground pad of the main board and fixes the metallic part and the ground pad of the main board at regular intervals.

4. The device of claim 1, wherein the main board includes a via connected to the ground pad, and the ground pad and the metallic part are electrically connected through the via.

5. The device of claim 1, wherein the metallic part comprises an outer surface of the portable wireless terminal.

6. The device of claim 5, wherein the metallic part comprises a plurality of metallic parts located on opposite sides of the portable wireless terminal.

7. The device of claim 6, wherein the plurality of metallic parts are electrically connected to be at the same ground potential.

8. The device of claim 7, wherein the plurality of metallic parts are electrically connected at the same ground potential by the conductor.

9. A built-in antenna device for a portable wireless terminal having a metallic part, the device comprising:
a main board including a feed pad for supplying an electrical signal and a ground pad connected to ground;
an antenna radiator connected electrically to the feed pad of the main board for radiating a signal;
at least one first connector electrically connecting the ground pad and the metallic part; and
a second connector electrically connecting the antenna radiator and the metallic part,
wherein the metallic part and the ground pad of the main board are at the same ground potential.

10. The device of claim 9, wherein each of the first connector and the second connector includes at least one of a session cable, a conductive tape, a conductive sponge, and a metallic plate.

11. The device of claim 9, wherein the second connector includes at least one of an elastic spring, a metallic rod, a metallic screw, and a pin that electrically connects the antenna radiator and the metallic part and fixes the antenna radiator and the metallic part at regular intervals.

12. The device of claim 9, wherein the first connector includes at least one of an elastic spring, a metallic rod, a metallic screw, and a pin that electrically connects the metallic part and the ground pad of the main board and fixes the metallic part and the ground pad of the main board at regular intervals.

13. The device of claim 9, wherein the main board includes a via connected to the ground pad, and the first connector is electrically connected to the via.

14. The device of claim 9, wherein the metallic part comprises an outer surface of the portable wireless terminal.

15. The device of claim 9, wherein the metallic part comprises a plurality of metallic parts located on opposite sides of the portable wireless terminal.

16. The device of claim 15, wherein the plurality of metallic parts are electrically connected to be at the same ground potential.

17. The device of claim 16, wherein the plurality of metallic parts are electrically connected at the same ground potential by at least one of the first connector and the second connector.
